(19) United States
(12) Patent Application Publication
(10) Pub. No.: US 2016/0105104 A1
(43) Pub. Date: Apr. 14, 2016

(54) SWITCHING CONTROLLING CIRCUIT, CONVERTER USING THE SAME, AND SWITCHING CONTROLLING METHOD

(71) Applicant: SOLUM CO., LTD., Suwon-si (KR)

(72) Inventors: Bo Hyun HWANG, Suwon-si (KR); Jin Soo LEE, Suwon-si (KR); Seung Kon KONG, Suwon-si (KR); Jung Eui PARK, Suwon-si (KR); Min Young AHN, Seongnam-si (KR)

(73) Assignee: SOLUM CO., LTD., Suwon-si (KR)

(21) Appl. No.: 14/816,792

(22) Filed: Aug. 3, 2015

(30) Foreign Application Priority Data
Oct. 8, 2014 (KR) 10-2014-0136119

(51) Int. Cl. H02M 3/156

(52) U.S. Cl. CPC H02M 3/156

(57) ABSTRACT

A converter includes a switching unit; an energy storage unit storing energy from DC input power and then generating an output voltage, depending on a switching operation of the switching unit; and a switching control unit turning on the switching unit when a voltage between one terminal and the other terminal of the switching unit reaches a lowest point of a resonance waveform. The switching control unit includes a voltage detection unit detecting the voltage between the one terminal and the other terminal at the time of the resonance waveform; a first signal output unit outputting a first signal when the voltage detected by the voltage detection unit reaches a change point of a slope corresponding to the lowest point of the resonance waveform; and a switching driving unit turning on the switching unit in response to the first signal.

This application claims the foreign priority benefit under 35 U.S.C. Section [120, 119, 119(e)] of Korean Patent Application Serial No. 10-2014-0136119, entitled “Switching Controlling Circuit, Converter Using The Same, And Switching Controlling Method” filed on Oct. 8, 2014, which is hereby incorporated by reference in its entirety into this application.

### BACKGROUND OF THE INVENTION

1. Technical Field

Embodiments of the present invention relates to a switching controlling circuit, a converter using the same, and a switching controlling method.

2. Description of the Related Art

With the development of a semiconductor integrated circuit, miniaturization and weight reduction of a system unit in an electronic communication apparatus have been rapidly achieved but miniaturization and weight reduction a power supply unit have not been achieved as expected due to energy storage devices such as an inductor and a capacitor.

Therefore, to keep pace with the recent trend of the miniaturization and weight reduction of the electronic communication apparatus, it is very important to make a power supply apparatus, in particular, a converter used in a switching mode power supply (SMPS), and the like, small and light.

In the converter used in the SMPS, and the like, the higher the switching frequency, the smaller the capacity of the energy storage device. As a result, the miniaturization and weight reduction of converter may be achieved by high-speed switching.

However, in the case of increasing the switching frequency using the high-speed semiconductor switching device, and the like, problems of a switching loss, heat generation from the switching device, and the like occur and surge, noise, and the like occur due to inductance and capacitance components in a circuit and an effect of accumulated charge of a diode, and the like, and as a result, reliability of the SMPS itself deteriorates.

### SUMMARY OF THE INVENTION

An aspect of the present disclosure is to provide a switching control circuit capable of implementing soft-switching using a simple circuit configuration, a converter using the same, and a switching controlling method.

According to an exemplary embodiment of the present disclosure, there are provided a switching control circuit turning on a switching device, when a voltage across a switching device reaches a lowest point of a resonance waveform, a converter using the same, and a switching controlling method.

According to an exemplary embodiment of the present disclosure, there are provided a switching control circuit turning on a switching device only by using a configuration of a differentiator, a comparator, and the like, a converter using the same, and a switching controlling method.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram schematically illustrating current and voltage waveforms of a switching device according to a switching scheme.

FIG. 2 is a schematic circuit diagram of a converter which is generally used currently.

FIG. 3 is a graph illustrating operation waveforms of the converter of FIG. 2 depending on input/output conditions.

FIG. 4 is a diagram for describing a switching loss in a hard-switching scheme.

FIG. 5 is a schematic circuit diagram of the converter according to an exemplary embodiment of the present disclosure.

FIG. 6 is a graph illustrating a signal waveform for main parts of the converter of FIG. 5.

FIG. 7 is a graph illustrating operation waveforms of the converter of FIG. 5 depending on a DC input power condition.

FIG. 8 is a graph for describing the DC input power condition which may implement zero voltage switching.

FIG. 9 is a schematic circuit diagram of a first signal output unit according to an exemplary embodiment of the present disclosure.

FIG. 10 is a graph illustrating signal waveforms for a main part of the first signal output unit of FIG. 9.

FIG. 11 is a graph illustrating waveforms of a differential voltage and a first signal depending on a current source condition of a voltage level reducing unit.

### DESCRIPTION OF EMBODIMENTS

Matters of an action effect and a technical configuration of a switching control circuit, a converter using the same, and a switching controlling method according to an exemplary embodiment of the present disclosure to achieve the above object will be clearly obvious by the following detailed description with reference to the drawings which illustrate exemplary embodiments of the present disclosure.

Further, when it is determined that the detailed description of the known art related to the present disclosure may obscure the gist of the present disclosure, the detailed description thereof will be omitted. Additionally, components shown in the accompanying drawings are not necessarily shown to scale. For example, sizes of some components shown in the accompanying drawings may be exaggerated as compared with other components in order to assist in understanding of exemplary embodiments of the present disclosure. Further, like reference numerals on different drawings will denote like components, and similar reference numerals on different drawings will denote similar components, but are not necessarily limited thereto.

In the present specification, the terms first, second, and so on are used to distinguish one element from another element, and the elements are not defined by the above terms.

Necessity of Soft-Switching

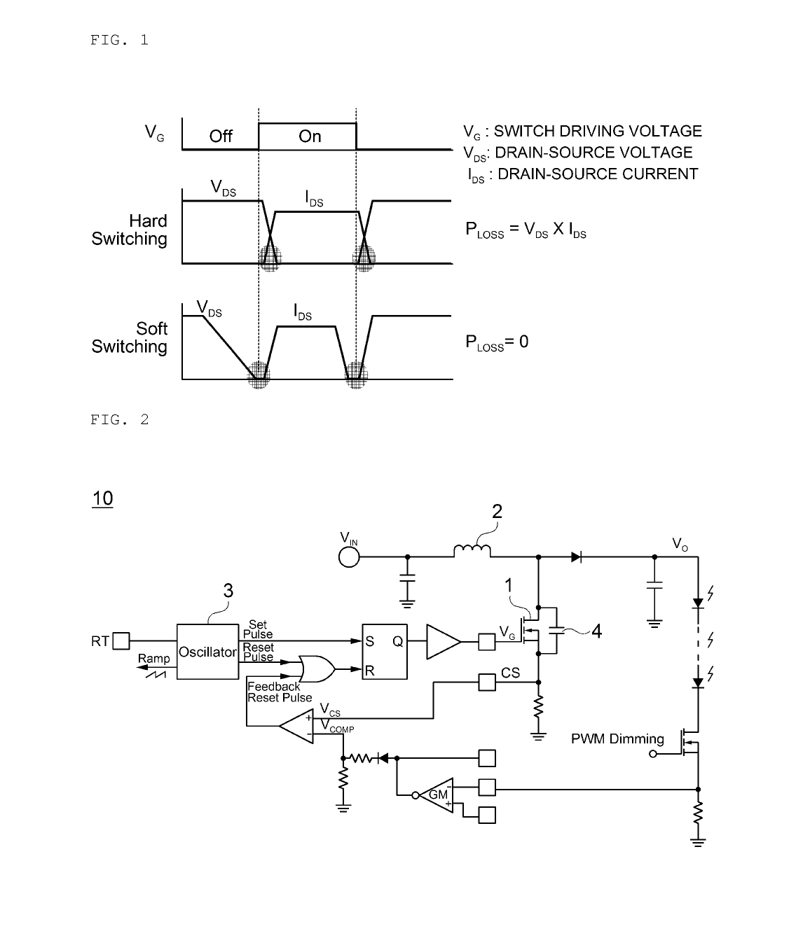

FIG. 1 is a diagram schematically illustrating current and voltage waveforms of a switching device according to a switching scheme.

As illustrated in FIG. 1, in the case of a hard-switching scheme, a switching loss (portion where P_{LOSS}, drain-source voltage V_{DS}, and drain-source current I_{DS} overlap each other) at the time of switching of the switching device occurs.

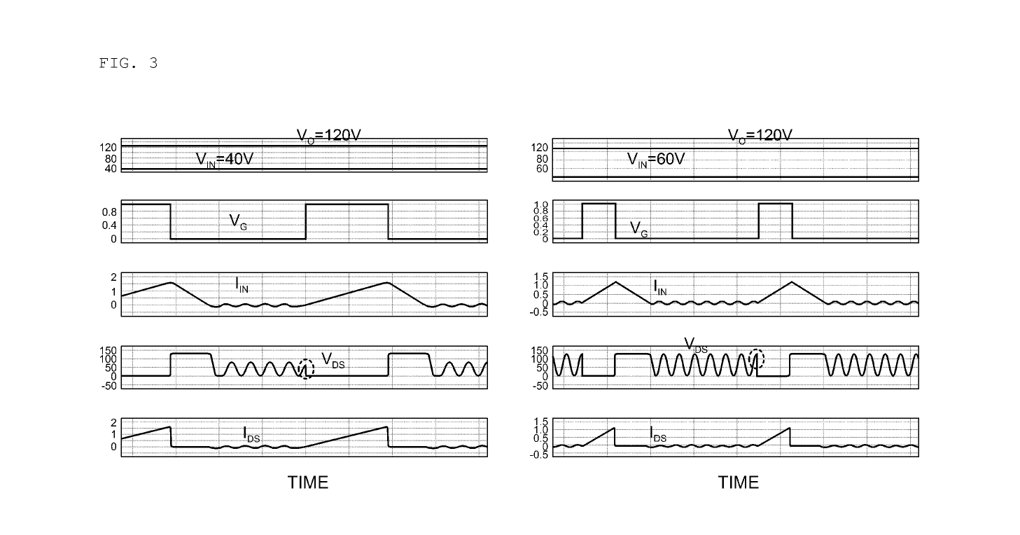

As described above, the switching loss occurs even in a converter which is generally used currently in an SMPS, which will be described below with reference to FIGS. 2 and 3.

First, FIG. 2 is a schematic circuit diagram of a converter 10 which is generally used currently and FIG. 3 is a graph illustrating operation waveforms of the converter 10 of FIG. 2 depending on input and output conditions.

Referring to FIGS. 2 and 3, when a switching device 1 is turned on (when V_{G} is converted into a high level), an inductor 2 stores energy while an inductor current I_{IN} is increased. Further, when the switching device 1 is turned off (when V_{G} is converted into a low level), the energy stored in the inductor 2 is transferred as an output voltage V₀ of the converter 10.

Next, when a current of the inductor 2 is completely discharged, the inductor 2 and aparasitic capacitor (not illustrated) of the switching device 1 or the inductor 2 and a snubber capacitor 4 perform resonance that a fluctuation of the current I_{DS} flowing in the switching device 1 in a positive (+) direction and a negative (−) direction is continuously repeated, such that the voltage V_{DS} across the switching device 1 may also be resonated at the same frequency as the current I_{DS} at the switching device 1.

In this case, as illustrated in FIG. 3, hard switching which turns on the switching device 1 at any voltage level (see a broken line portion of FIG. 3) at which a resonance waveform of the voltage V_{DS} across the switching device 1 is not minimized is generated in the converter 10 of FIG. 2, such that problems of a switching loss, heat generation from a switching device, and the like occur.

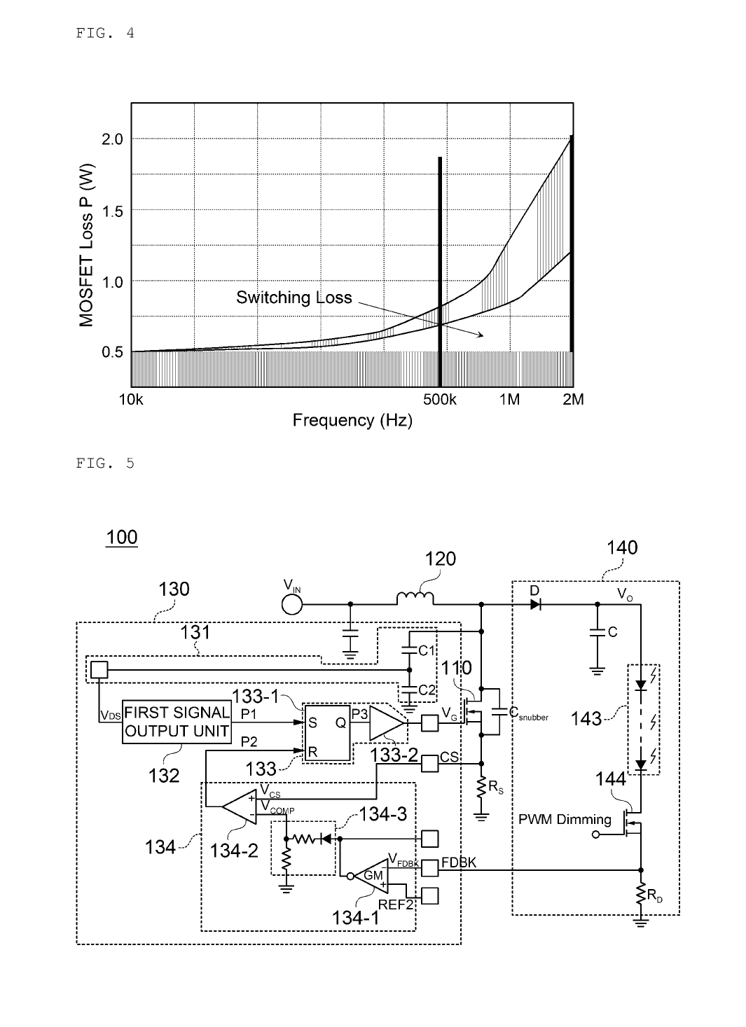

The switching loss in the hard switching scheme will be described in more detail with reference to FIG. 4. As illustrated in FIG. 4, in the case of the hard switching scheme, it may be confirmed that the switching loss is increased in proportion to a frequency at a high switching frequency of MHz or more.

Therefore, to reduce the switching loss due to the high speed switching, as illustrated in FIG. 1, a driving of a so-called soft-switching scheme which switches a switching device which makes the switching loss P_{LOSS} zero (including a range in which the switching loss substantially approximates 0) is required.

For example, when the switching device is turned off and then the voltage across the switching device reaches a lowest point at the resonance waveform, a switching driving of a so-called valley switching scheme, and the like which turns on the switching device is required.

Therefore, the exemplary embodiment of the present disclosure adopts the valley switching which may perform the soft switching by turning on the switching device when the voltage across the switching device reaches the lowest point at the resonance waveform, but adopts a switching control configuration example in which the valley switching may be made only by a simple circuit configuration. This will be described below in detail.

### One Exemplary Embodiment of the Present Disclosure

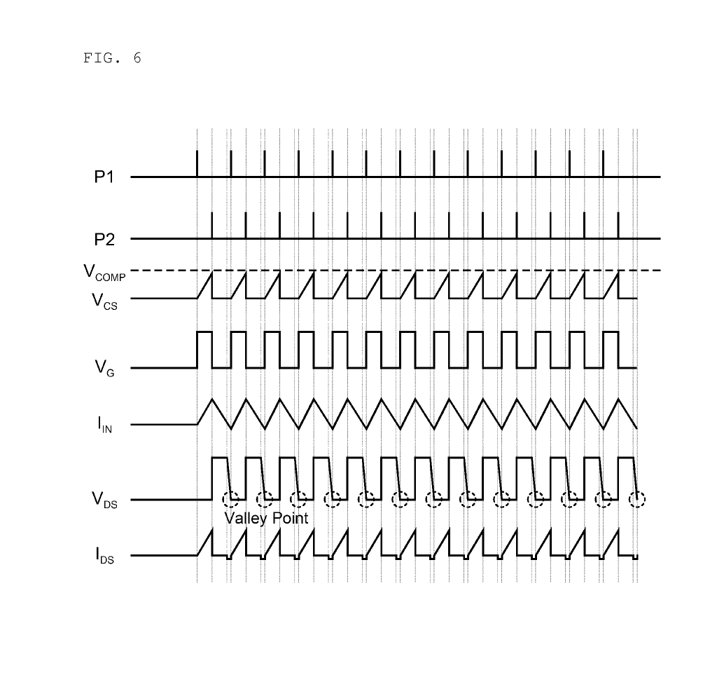

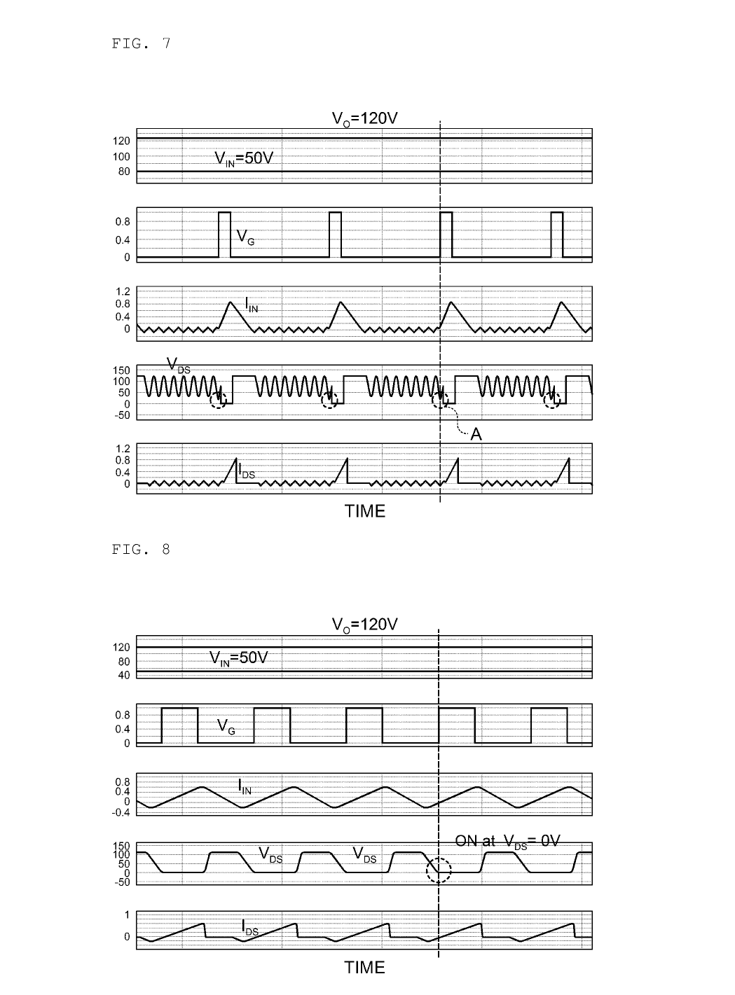

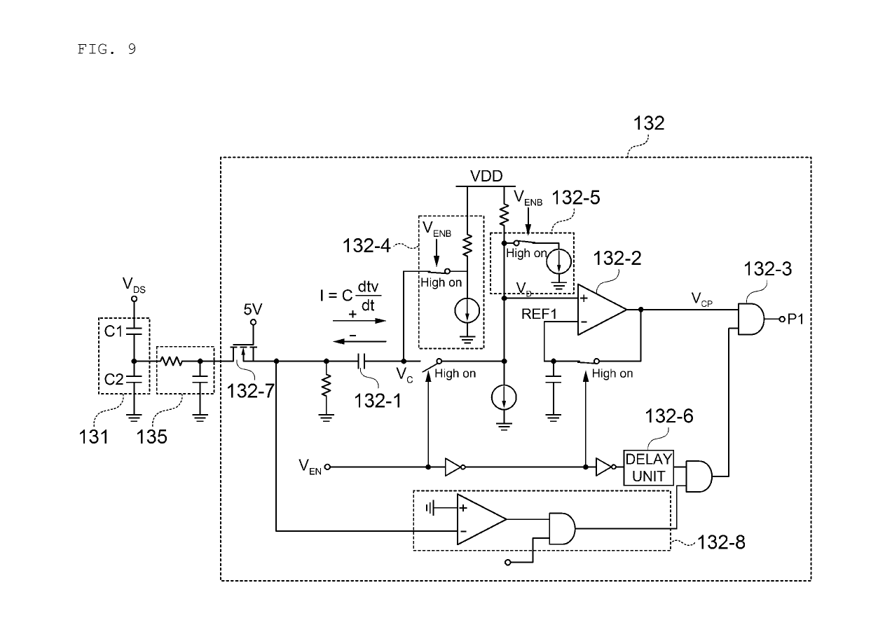

FIG. 5 illustrates a schematic circuit diagram of a converter 100 according to one exemplary embodiment of the present disclosure, FIG. 6 is a graph illustrating a signal waveform of main parts of the converter 100 of FIG. 5, and FIG. 7 is a graph illustrating the operation waveforms of the converter 100 of FIG. 5 depending on a DC input power VIN condition.

The case in which the exemplary embodiment of the present disclosure is implemented as a boost converter is described, but the present disclosure is not limited thereto. Further, the converter 100 according to the exemplary embodiment of the present disclosure is set to supply power to an LED string 143 in which a plurality of LED devices are connected to each other in series, but the present disclosure is not limited thereto.

As illustrated in FIG. 5, the converter 100 according to the exemplary embodiment of the present disclosure may include a switching unit 110, an energy storage unit 120, a switching control unit 130, and an output unit 140.

Further, even though the converter 100 according to the exemplary embodiment of the present disclosure is not illustrated in the drawing, the converter 100 may include a power supply unit which rectifies AC input power to generate DC input power V_{IN}, in which the power supply unit may include a bridge diode, a line filter, and the like.

In this case, the bridge diode may be configured of four diodes and full-wave-rectifies the AC input power to generate the DC input power V_{IN} in FIG. 5.

Further, the line filter may include two capacitors which are connected to both terminals, to which AC power is input, in parallel and two inductors which are connected to each of the both terminals, to which the AC power is input, in series.

In this case, the line filter filters an electromagnetic interference of the AC input power.

Meanwhile, the switching unit 110 according to the exemplary embodiment of the present disclosure may be implemented as an FET switching device, but the exemplary embodiment of the present disclosure is not limited thereto, and therefore any switching device which may perform the switching operation may be adopted.

The switching unit 110 according to the exemplary embodiment of the present disclosure has a parasitic capacitor formed between a drain electrode and a source electrode thereof and as illustrated in FIG. 5, may be connected with a snubber capacitor C_{snubber} in parallel.

Hereinafter, the voltage across the switching unit 110 is referred to as the “drain voltage V_{DS}” and the current flowing in the switching unit 110 is referred to as the “drain current I_{DS}”.

Further, the energy storage unit 120 according to the exemplary embodiment of the present disclosure may generally be implemented as an inductor and as illustrated in FIG. 5, one terminal of the energy storage unit 120 is supplied with the DC input power V_{IN} and the other terminal thereof is connected to an anode of an output diode D and one terminal (drain electrode) of the switching unit 110.

The DC input power V_{IN} is transferred to the energy storage unit 120, in which the energy storage unit 120 stores energy from a current (hereinafter, “current I_{IN} of the energy storage unit”) flowing in the energy storage unit 120 by the DC input power V_{IN} and then generates an output voltage V₀ using the stored energy.

As described above, the storage of the energy and the generation of the output voltage V₀ by the energy storage unit 120 are controlled by a switching operation of the switching unit 110.

That is, referring to FIGS. 5 and 6, while the switching unit 110 is turned on (in the exemplary embodiment of the present disclosure, in a section in which V_{G} of FIG. 6 is in a high level), the current I_{IN} of the energy storage unit is increased and thus the energy storage unit 120 stores energy. Further, while the switching unit 110 is turned off (in the exemplary embodiment of the present disclosure, in a section in which the V_{G} of FIG. 6 is in a low level), the current I_{IN} of the energy storage unit flows through the output diode D and the energy stored in the energy storage unit 120 is transferred to the output unit 140, thereby generating the output voltage V₀.

Meanwhile, when the switching unit 110 is turned off and the output diode D is conducted, the current I_{IN} of the energy storage unit flows in a load 143 (in the exemplary embodiment of the present disclosure, LED string) of the output unit 140, which in turn charges an output capacitor C.

In this case, since the load is increased and the current I_{IN} of the energy storage unit supplied to the load 143 is increased correspondingly, the current flowing in the output capacitor C is relatively reduced and the output voltage V₀ is relatively reduced correspondingly.

On the contrary, since the load is reduced and the current I_{IN} of the energy storage unit supplied to the load 143 is reduced correspondingly, the current flowing in the output capacitor C is relatively increased and the output voltage V₀ is relatively increased correspondingly.

The output voltage V₀ may be constantly kept regardless of the fluctuation of the load by the foregoing operation.

Further, when the energy of the energy storage unit 120 is completely supplied to the load 143, the output diode D is cutoff. In this case, as illustrated in FIG. 6, the drain voltage V_{DS} of the switching unit 110 is reduced due to resonance between the energy storage unit 120 and the parasitic capacitor of the switching unit 110 or between the energy storage unit 120 and the snubber capacitor C_{snubber}.

Further, as illustrated in FIG. 6, a period in which the current I_{IN} of the energy storage unit flows reversely is generated due to the resonance between the energy storage unit 120 and the parasitic capacitor or between the energy storage unit 120 and the snubber capacitor C_{snubber} while the switching unit 110 is turned off.

Further, referring to FIGS. 5 and 6, the drain voltage V_{DS} is reduced and then the switching unit 110 is turned on, and as a result, the current I_{IN} of the energy storage unit flows through the switching unit 110. In this case, as illustrated in FIG. 6, while the switching unit 110 is turned on, the drain current I_{DS} is equal to the current I_{IN} of the energy storage unit.

Meanwhile, as illustrated in FIG. 5, the converter 100 according to the exemplary embodiment of the present disclosure may further include a sensing resistor R_{S}.

The sensing resistor R_{S} is connected between the source electrode of the switching unit 110 and a ground and thus a sensing voltage V_{CS} is generated. The sensing voltage V_{CS} is generated through the drain current I_{DS} flowing in the sensing resistor R_{S}, and thus information of the current I_{IN} of the energy storage unit is reflected.

In this case, since the drain current I_{DS} flows from one terminal of the sensing resistor R_{S} to the other terminal, according to the exemplary embodiment of the present disclosure, the sensing voltage V_{CS} becomes a positive voltage as illustrated in FIG. 6.

Meanwhile, the switching control unit 130 according to the exemplary embodiment of the present disclosure turns on the switching unit 110 when the drain voltage V_{DS} reaches the lowest point of the resonance waveform (when the resonance waveform of the drain voltage is the lowest voltage).

The switching control unit 130 uses the drain voltage V_{DS} to detect the lowest point of the resonance waveform.

That is, the switching control unit 130 detects the drain voltage when the resonance starts, that is, the drain voltage V_{DS} at the time of the resonance waveform and detects when the detected slope of drain voltage V_{DS} is changed, that is, a change point (hereinafter, “valley point”) of the slope, thereby detecting the lowest point of the resonance waveform.

By the switching control unit 130 as described above, the converter 100 according to the exemplary embodiment of the present disclosure may perform the valley switching which turns on the switching unit 110 when the drain voltage V_{DS} of the switching unit 110 reaches a lowest point A of the resonance waveform as illustrated in FIG. 7.

Therefore, according to the exemplary embodiment of the present disclosure, the hard switching is prevented and the soft switching of the switching device may be made, such that the problems of the switching loss, the heat generation of the switching device, and the like due to the high-speed switching may be minimized. As a result, the exemplary embodiment of the present disclosure reduces the capacity of the inductor, the capacitor, and the like, thereby achieving miniaturization and weight reduction.

However, when a voltage level of the DC input power V_{IN} is equal to or less than 50% of the output voltage V₀, as illustrated in FIG. 8, a zero point may be detected in a resonance section of the drain voltage V_{DS}, and therefore the soft switching may be made by the zero voltage switching operation.

Therefore, the valley switching scheme according to the exemplary embodiment of the present disclosure is preferably adapted when as illustrated in FIG. 7, the voltage level of the DC input power VIN is more than 50% of the voltage level of the output voltage V₀ and thus the zero point may not be detected in the resonance section of the drain voltage V_{DS}.

Hereinafter, the configuration of the switching control unit 130 as described above will be described in more detail.

The switching control unit 130 according to the exemplary embodiment of the present disclosure may include a voltage detection unit 131, a first signal output unit 132, and a switching driving unit 133, as illustrated in FIG. 5.

The voltage detection unit 131 detects the drain voltage V_{DS} when the resonance starts, that is, the drain voltage V_{DS} at the time of the resonance waveform.

In this case, as illustrated in FIG. 5, the voltage detection unit 131 may have a form of a voltage divider which is configured of a plurality of capacitors C1 and C2 connected between the drain electrode of the switching unit 110 and the ground. However, the present disclosure is not limited thereto, and therefore the voltage detection unit 131 may have a form of the voltage divider which is configured of, for example, a plurality of voltage dividing resistors, instead of the plurality of capacitors. However, when the voltage divider is configured of the plurality of voltage dividing resistors, a leakage current may occur at a boost stage, and therefore the voltage divider is more preferably configured of the plurality of capacitors.

The first signal output unit 132 outputs a first signal P1 which may turn on the switching unit 110 when the voltage V_{DS} distributed and detected by the voltage detection unit 131 reaches the change point of the slope corresponding to the lowest point of the resonance waveform, that is, the valley point.

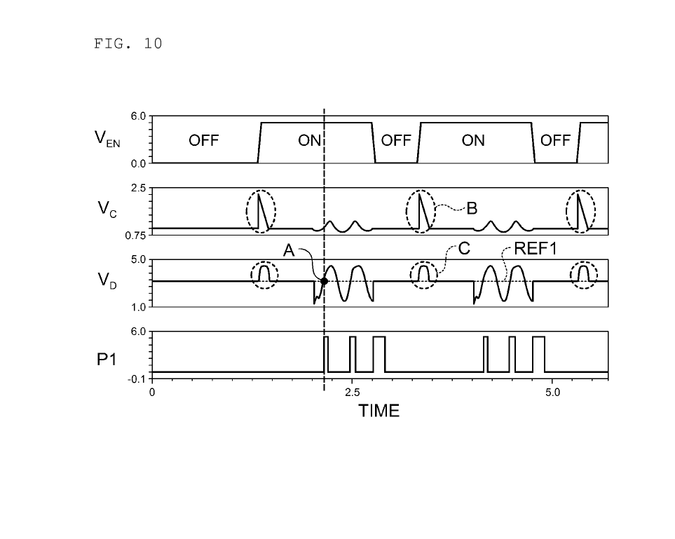

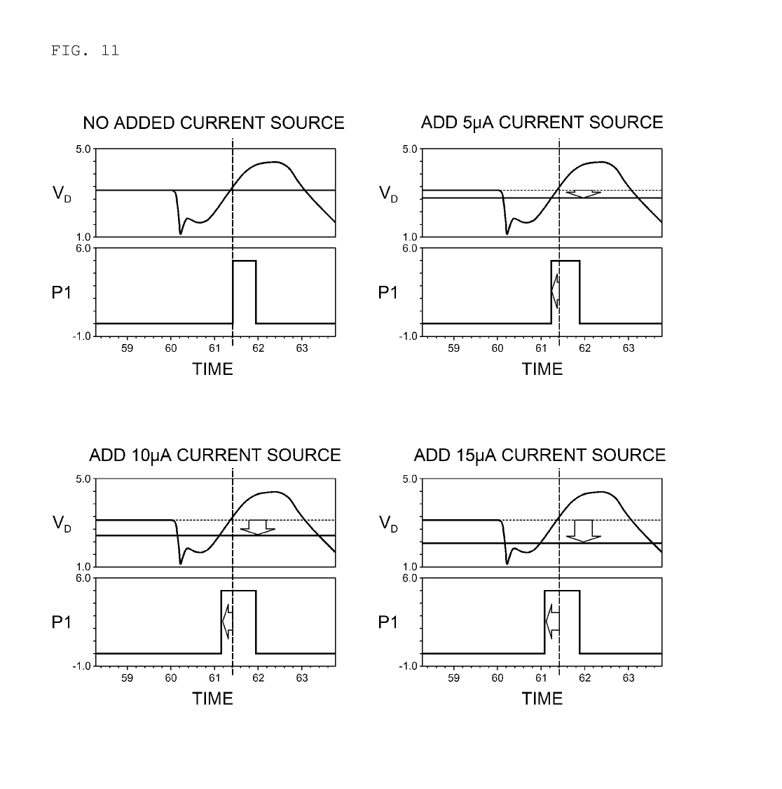

FIG. 9 illustrates a schematic circuit diagram of the first signal output unit 132 as described above and FIG. 10 is a graph illustrating signal waveforms of main parts of the first signal output unit 132.

As illustrated in FIG. 9, the first signal output unit 132 may include a differentiator 132-1, a first comparator 132-2, and a signal output terminal 132-3 and detects the valley point and outputs the first signal P1 depending on an enable signal V_{EN}.

As illustrated in FIG. 9, the differentiator 132-1 has one terminal connected to the voltage detection unit 131 and thus detects information on the slope of the drain voltage V_{DS} as detected by the voltage detection unit 131.

That is, as illustrated in FIG. 9, the differentiator 132-1 may have a form of a capacitor of which the one terminal is connected to the voltage detection unit 131 and may use a current characteristic of the capacitor (that is, current characteristic including a differential component of the drain voltage V_{DS} depending on a voltage variation (dv/dt) across the capacitor to detect the information on the slope of the drain voltage V_{DS}.

As illustrated in FIG. 9, the first comparator 132-2 includes an inversion input terminal (−) to which a first reference voltage REF1 is input and a non-inversion input terminal (+) to which a voltage (hereinafter, “differential voltage (V_{D})”) corresponding to a current flowing in the differentiator 132-1 is input.

The first comparator 132-2 according to the exemplary embodiment of the present disclosure outputs a low-level comparison signal V_{CP} when the differential voltage V_{D} is smaller than the first reference voltage REF1 and outputs a high-level comparison signal V_{CP} when the differential voltage V_{D} is larger than the first reference voltage REF1.

In this case, as illustrated in FIG. 10, the first reference voltage REF1 may be a voltage which is obtained by performing sampling/hold on the differential voltage V_{D} when there is no change in slope. As illustrated in FIG. 10, the first reference voltage REF1 may be a voltage which is obtained by performing the sampling and hold on the differential voltage V_{D} while the low-level (off) enable signal V_{EN} is applied and thus the valley point detection is not performed, that is, the switching unit 110 is turned on.

The signal output terminal 132-3 outputs the first signal P1 which may turn on the switching unit 110 depending on the comparison signal V_{CP} output from the first comparator 132-2 and according to the exemplary embodiment of the present disclosure, outputs the first signal P1 when the high-level comparison signal V_{CP} is output.

Hereinafter, referring to FIGS. 9 and 10, an operation of the first signal output unit 132 according to the exemplary embodiment of the present disclosure will be described.

In the section in which the drain voltage V_{DS} resonates, the high-level (on) enable signal V_{EN} is applied and thus the switching device of the other terminal of the differentiator 132-1 is turned on, such that the first signal output unit 132 performs the valley point detection operation.

Next, the information on the slope of the drain voltage V_{DS} is detected by using the current characteristic of the capacitor depending on the voltage variation across the differentiator 132-1 and in the direction in which the drain voltage V_{DS} is reduced, a direction of a current flowing in the differentiator 132-1 becomes a negative (−) direction and thus the current flows out from the first comparator 132-2.

In this case, a current supplied from a driving power supply VDD is increased as much as a current amount flowing out from the first comparator 132-2, and as a result, a voltage drops due to resistor and the differential voltage V_{D} is reduced correspondingly.

Therefore, the differential voltage V_{D} is lower than the first reference voltage REF1, and thus the first comparator 132-2 outputs the low-level comparison signal V_{CP}.

Next, in the case in which the drain voltage V_{DS} is changed in an increasing direction, the direction of the current flowing in the differentiator 132-1 becomes a positive (+) direction and thus the current flows in the first comparator 132-2.

Therefore, the differential voltage V_{D} is higher than the first reference voltage REF1, and thus the first comparator 132-2 outputs the high-level comparison signal V_{CP}.

The signal output terminal 132-3 outputs the first signal P1 to the switching driving unit 133 depending on the high-level comparison signal V_{CP}, and thus the switching driving unit 133 outputs the high-level switching driving signal V_{G} depending on the first signal P1 as illustrated in FIGS. 5 and 6 to turn on the switching unit 110.

That is, the first signal output unit 132 according to the exemplary embodiment of the present disclosure outputs the first signal P1 when a direction of current flowing in the differentiator 132-1 is changed from a negative (−) direction to a positive (+) direction, that is, a slope (corresponding to the differential voltage V_{D}) of the drain voltage V_{DS} detected by the voltage detection unit 131 is changed from a negative (−) direction to a positive (+) direction and turns on the switching unit 110 depending on the first signal P1.

Referring to FIG. 2, the currently used converter 10 turns on the switching device 1 based on signals (set pulse, ramp, and the like) generated and output from an oscillator 3, and the like which fixes and determines the switching frequency of the switching device 1.

On the other hand, according to the exemplary embodiment of the present disclosure, the first signal P1 may be generated and output only by a simple circuit configuration such as a differentiator and a comparator, and therefore the soft switching may be performed without a complicated circuit configuration. Therefore, it is more preferable to implement the miniaturization, save the manufacturing costs, and the like.

Meanwhile, as illustrated in FIG. 9, the first signal output unit 132 may also include a voltage holding unit 132-4 and a voltage level reducing unit 132-5.

As illustrated in FIG. 9, the voltage holding unit 132-4 is connected to the other terminal of the differentiator 132-1 and may thus be configured as a current source, a switching device, thereby constantly holding the differential voltage V_{D} when the enable signal V_{EN} is turned on/off.

When the voltage holding unit 132-4 having the configuration as described above is not included in the exemplary embodiment of the present disclosure, the other terminal voltage V_{C} of the differentiator 132-1 is in a floating state like “B” illustrated in FIG. 10 at a timing when the enable signal V_{EN} is changed from off (low level) to on (high level) and then is connected to the differential voltage V_{D}, and therefore the differential voltage V_{D} is much fluctuated in a positive (+) direction.

Therefore, the voltage holding unit 132-4 having the configuration as described above is included in the exemplary embodiment of the present disclosure to minimize the fluctuation of the differential voltage V_{D} when the enable signal V_{EN} is turned on/off, in particular, when the enable signal V_{EN} is changed from the turn off state to the turn on state (see “C” of FIG. 10).

Further, the first signal output unit 132 according to the exemplary embodiment of the present disclosure may further include a delay unit 132-6 which delays the time until the first signal P1 is output after the enable signal V_{EN} is turned on as illustrated in FIG. 9 so as to prevent a malfunction due to the fluctuation of the differential voltage V_{D} as described above.

Meanwhile, as illustrated in FIG. 9, the voltage level reducing unit 132-5 is connected to a non-inversion input terminal (+) of the first comparator 132-2 and may thus be configured as the switching device, the current source, and the like, thereby reducing the voltage level of the first reference voltage REF1.

As illustrated in FIGS. 9 and 10, the first signal output unit 132 outputs the first signal P1 when the slope (corresponding to the differential voltage V_{D}) of the drain voltage V_{DS} detected by the voltage detection unit 131 is changed from a negative (−) direction to a positive (+) direction, that is, at the valley point A.

However, the error that the valley point is recognized after the slope is actually changed may occur and the so-called turn on delay phenomenon that the switching unit 110 is not turned on at the actual valley point but is turned on after that due to the phenomenon that the actual time from the first signal P1 until the switching unit 110 is turned on is delayed inside the first signal output unit 132, and the like occurs.

The foregoing turn on delay phenomenon may be solved by lowering the voltage level of the first reference voltage REF1 by the voltage level reducing unit 132-5 which adds loads such as a current source, and the like.

In other words, the detection timing of the valley point may be advanced within a range which does not greatly deviate from the valley section by lowering the voltage level of the first reference voltage REF1, thereby solving the turn on delay phenomenon. This may be clearly confirmed from FIG. 11 that illustrates the waveforms of the differential voltage V_{D} and the first signal P1 depending on the current source conditions of the voltage level reducing unit 132-5.

Further, as illustrated in FIG. 9, the first signal output unit 132 may further include a clamping transistor 132-7 between the voltage detection unit 131 and one terminal of the differentiator 132-1.

The clamping transistor 132-7 may lower and clamp the drain voltage V_{DS} detected by the voltage detection unit 131 to a predetermined magnitude of voltage to protect internal devices of the first signal output unit 132. In the exemplary embodiment of the present disclosure, a transistor which may clamp the voltage to a magnitude of 5V has been adopted. However, it is apparent that 5V, and the like, mentioned herein is only an example for describing the present disclosure, and therefore, in the exemplary embodiment of the present disclosure, components which may clamp the voltage to other magnitudes of voltage may be instead used. Further, when an internal pressure of the internal device is sufficient, the clamping transistor 132-7 may not be used.

Further, as illustrated in FIG. 9, the first signal output unit 132 may further include a clamping voltage comparison unit 132-8 which outputs the first signal P1 only when the voltage clamped by the clamping transistor 132-7 is equal to or less than a zero voltage to prevent a malfunction due to noise.

In this case, as illustrated in FIG. 9, the switching control unit 130 may further include a filter unit 135 which is disposed between the voltage detection unit 131 and the clamping transistor 132-7 and implemented as an RC filter form to remove noise, thereby more preventing a malfunction due to the noise.

Meanwhile, as illustrated in FIG. 5, the switching control unit 130 according to the exemplary embodiment of the present disclosure may also include a second signal output unit 134.

The second signal output unit 134 uses a feedback voltage V_{FDBK} which is obtained by voltage-dividing the output voltage V₀ by a voltage dividing resistor R_{D} of the output unit 140 and the sensing voltage V_{CS} generated by the sensing resistor R_{S} to output the second signal P2 which may turn off the switching unit 110.

In this case, as illustrated in FIG. 5, the feedback voltage V_{FDBK} is detected from a source electrode of a dimming switch 144 of the output unit 140 and then is input to an input pin FDBK of the switching control unit 130.

Further, as illustrated in FIG. 5, the sensing voltage V_{CS} is detected by the sensing resistor R_{S} and is then input to an input pin CS of the switching control unit 130.

As illustrated in FIG. 5, the second signal output unit 134 may include a second comparator 134-1 and a third comparator 134-2.

The second comparator 134-1 compares the feedback voltage V_{FDBK} with a second reference voltage REF2 which is an error reference voltage to amplify the error, thereby generating and outputting a comparison voltage V_{COMP} which is an error amplification signal.

In this case, as illustrated in FIG. 5, the second comparator 134-1 includes an inversion input terminal (−) to which the feedback voltage V_{FDBK} is input and a non-inversion input terminal (+) to which the second reference voltage REF2 is input.

Therefore, the second comparator 134-1 amplifies a voltage obtained by subtracting the feedback voltage V_{FDBK} from the second reference voltage REF2 which is the error reference voltage to generate the comparison voltage V_{COMP} which is the error amplification signal.

Further, the third comparator 134-2 compares the sensing voltage V_{CS} reflecting the information on the current I_{IN} of the energy storage unit with the comparison voltage V_{COMP} output from the second comparator 134-1 and generates and outputs the second signal P2 which may turn off the switching unit 110 depending on the comparison result.

In this case, as illustrated in FIG. 5, the third comparator 134-2 includes an inversion input terminal (−) to which the comparison voltage V_{COMP} is input and a non-inversion input terminal (+) to which the sensing voltage V_{CS} is input.

In this case, as illustrated in FIG. 6, the third comparator 134-2 outputs the second signal P2 to the switching driving unit 133 when the sensing voltage V_{CS} is equal to or more than the comparison voltage V_{COMP}, and thus as illustrated in FIGS. 5 and 6, the switching driving unit 133 outputs the low-level switching driving signal V_{G} depending on the second signal P2 to turn off the switching unit 110.

In the case of the exemplary embodiment of the present disclosure, the driving of the switching unit 110 may be controlled by controlling duties of the first and second signals P1 and P2 as described above, and thus the output voltage V₀ may be constantly held regardless of the fluctuation of the load 143 (in the exemplary embodiment of the present disclosure, LED string). Therefore, the current flowing in the load 143 may also be held constantly.

Further, the second signal output unit 134 according to the exemplary embodiment of the present disclosure may also include a comparison voltage dividing unit 134-3.

In this case, as illustrated in FIG. 5, the comparison voltage dividing unit 134-3 is connected between an output terminal of the second comparator 134-1 and an inversion input terminal (−) of the third comparator 134-2 to divide the comparison voltage V_{COMP} output from the second comparator 134-1 and output the divided voltage to the inversion input terminal (−) of the third comparator.

Meanwhile, as illustrated in FIG. 5, the switching driving unit 133 according to the exemplary embodiment of the present disclosure may include a third signal output unit 133-1 and a switching driving signal output unit 133-2.

As illustrated in FIG. 5, the third signal output unit 133-1 generates and outputs a third signal P3 for generating the switching driving signal V_{G} depending on the first signal P1 output from the first comparator 132 and the second signal P2 output from the second signal output unit 134. The exemplary embodiment of the present disclosure describes that the third signal output unit 133-1 is implemented as an SR flip-flop, but is not limited thereto.

As illustrated in FIG. 5, the third signal output unit 133-1 may include a first signal input terminal S (set terminal) to which the first signal P1 is input, a second signal input terminal R (reset terminal) to which the second signal P2 is input, and an output terminal Q to which the third signal P3 is output.

Therefore, the third signal output unit 133-1 outputs the third signal P3 corresponding to the first signal P1 or the second signal P2. For example, the third signal output unit 133-1 according to the exemplary embodiment of the present disclosure generates a high-level output depending on the first signal P1 which is input to the first signal input terminal S and generates a low-level output depending on the second signal P2 which is input to the second signal input terminal R.

Further, the switching driving signal output unit 133-2 outputs the switching driving signal V_{G} which turns on/off the switching unit 110 depending on the third signal P3 output from the third signal output unit 133-1.

For example, the switching driving signal output unit 133-2 according to the exemplary embodiment of the present disclosure generates the high-level switching driving signal V_{G} when being applied with the high-level third signal P3 and outputs the generated high-level switching driving signal V_{G} to the switching unit 110 and generates the low-level switching driving signal V_{G} when being applied with the low-level third signal P3 and outputs the generated low-level switching driving signal V_{G} to the switching unit 110.

As illustrated in FIG. 5, the switching unit 110 according to the exemplary embodiment of the present disclosure adopts an N channel type FET switching device, and therefore when the switching driving signal V_{G} is in a high level, the switching unit 110 is turned on and when the switching driving signal V_{G} is in a low level, the switching unit 110 is turned off.

Hereinafter, the switching operation according to the exemplary embodiment of the present disclosure will be described with reference to FIGS. 5, 6, 9, and 10.

In the state in which the DC input power V_{IN} is applied, the switching unit 110 is turned on and then turned off. Thereafter, when the energy of the energy storage unit 120 is completely supplied to the load 143 (in the exemplary embodiment of the present disclosure, LED string), the output diode D is cutoff.

In this case, the drain voltage V_{DS} generates the resonance waveform due to a resonance between the energy storage unit 120 and the parasitic capacitor of the switching unit 110 or the resonance between the energy storage unit 120 and the snubber capacitor C_{snubber}.

At the time of the resonance waveform, the drain voltage V_{DS} is detected by the voltage detection unit 131 and the detected drain voltage V_{DS} is input to the first signal output unit 132.

In this case, the first signal output unit 132 is applied with the high-level enable signal V_{EN} and thus the switching device of the other terminal of the differentiator 132-1 is turned on, such that the valley point detection operation is performed.

Next, the information on the slope of the drain voltage V_{DS} is detected using the current characteristic of the capacitor depending on the voltage variation across the differentiator 132-1 and when the drain voltage V_{DS} is changed from a decreasing direction to an increasing direction, the high-level comparison signal V_{CP} is output. The first signal P1 depending on the high-level comparison signal V_{CP} is output through the first signal output unit 132.

Depending on the first signal P1, the high-level switching driving signal V_{G} is output through the switching driving unit 133, and thus the switching unit 110 is turned on. Next, the current I_{IN} of the energy storage unit is increased while the switching unit 110 is turned on and thus the energy storage unit 120 stores energy.

Meanwhile, the feedback voltage V_{FDBK} is detected from the source electrode of the dimming switch 144 in the section in which the dimming switch 144 is turned on and the feedback voltage V_{FDBK} is compared with the second reference voltage REF2 (error reference voltage) to amplify the error, to thereby output the comparison voltage V_{COMP} which is the error amplification voltage.

Next, the sensing voltage V_{CS} reflecting the information on the current I_{IN} of the energy storage unit is detected by the sensing resistor R_{S} and the second signal P2 is output by comparing the sensing voltage R_{S} with the comparison voltage V_{COMP}.

Depending on the second signal P2, the low-level switching driving signal V_{G} is output through the switching driving unit 133, and thus the switching unit 110 is turned off.

When the switching unit 110 is turned off and the output diode D is conducted, the current I_{IN} of the energy storage unit flows in the load 143 and thus the output capacitor C is charged. Next, when the energy of the energy storage unit 120 is completely supplied to the load 143, the drain voltage V_{DS} again resonates. In this case, the foregoing operation is repeated to perform the switching operation.

As a result, according to the exemplary embodiment of the present disclosure, the duty of the switching driving signal V_{G} may be controlled by controlling the duties of the first and second signals P1 and P2 as described above, such that the switching operation of the switching unit 110 may be controlled. Therefore, depending on the switching control, the output voltage V₀ is constantly held regardless of the fluctuation of the load, and as a result, the current flowing in the load 143 is also held constantly.

Further, according to the exemplary embodiment of the present disclosure, as described above, the switching unit 110 may be turned on depending on the first signal P1 reflecting the information on the lowest point of the drain voltage V_{DS} in the resonance section. In this case, the drain current I_{DS} flows in the switching unit 110, and thus the valley switching may be made. As a result, the hard switching is prevented and the soft switching of the switching unit 110 may be made, thereby minimizing the problems of the switching loss, the heat generation of the switching device, and the like due to the high-speed switching.

Further, according to the exemplary embodiment of the present disclosure, the first signal P1 may be generated and output only by a simple circuit configuration such as a differentiator and a comparator, and therefore the soft switching may be performed without a complicated circuit configuration such as an oscillator.

Function of various components illustrated in the drawings of the present disclosure may be provided by using hardware which may associated with appropriate software to run software and dedicated hardware. When provided by a processor, these functions may be provided by a single dedicated processor, a single sharing processor, or a plurality of individual processors which may share a portion thereof.

Further, the explicit use of the term “control unit” is not to be construed as exclusively designating hardware which may execute software and a microcontroller unit (MCU), digital signal processor (DSP) hardware, a read only memory (ROM) for storing software, a random access memory (RAM), a non-volatile storage device may be implicitly included without being limited.

In claims in the present specification, elements represented as a means for performing a specific function include any scheme performing the specific functions and the elements may include a combination of circuit elements performing the specific function or software in any form including firmware, microcode, and the like which are coupled with a circuit suitable to perform software for performing the specific function.

In the present specification, ‘one embodiment’ of principles of the present disclosure and names for various changes of the expression mean that specific features, structures, characteristics, and the like, associated with the embodiment are included in at least one embodiment of the principle of the present disclosure.

Therefore, the expression ‘one embodiment’ and any other modification examples disclosed throughout the present specification do not necessarily mean the same embodiment.

In the present specification, in the case in which it is described that a method includes a series of steps, a sequence of these steps suggested herein is not necessarily a sequence in which these steps may be executed. That is, any described step may be omitted and/or any other step that is not described herein may be added to the method.

The designation of various changes of expressions such as “connected” and “connecting”, and the like in the present specification means that one element may be connected directly to or coupled directly to another component by an electrical or non-electrical scheme.

Further, in the present specification, targets described as being “adjacent to” each other may physically contact each other, be close to each other, or be in the same general range or region, in the context in which the above phrase is used.

In addition, terms used in the present specification are for explaining the embodiments rather than limiting the present disclosure. Unless explicitly described to the contrary, a singular form includes a plural form in the present specification. In addition, components, steps, operations, and elements mentioned in the present specification do not exclude the existence or addition of one or more other components, steps, operations, elements and apparatuses.

As set forth above, according to the exemplary embodiments of the present disclosure, it is possible to minimize the problems of the switching loss, the heat generation of the switching device, and the like, due to the high-speed switching.

Further, as set forth above, according to the exemplary embodiments of the present disclosure, it is possible to achieve the miniaturization and weight reduction in response to the reduction in capacity of the inductor, the capacitor, and the like.

In addition, as set forth above, according to the exemplary embodiments of the present disclosure, it is possible to achieve the miniaturization, save the manufacturing costs, and the like by the simple circuit configuration.

However, a scope of the present disclosure is not limited to the foregoing effects.

Hereinabove, the present disclosure has been described with reference to exemplary embodiments thereof. All the embodiments and conditional examples disclosed in the present specification are described to help a person having ordinary skilled in the art to which the present disclosure pertains to understand the principle and concept of the present disclosure and those skilled in the art may understand that the present disclosure may be implemented in a modified form within a range which does not deviate from the essential characteristics of the present disclosure. The scope of the present disclosure should be defined by the following claims rather than the above-mentioned description, and all technical spirits equivalent to the following claims should be interpreted as being included in the present disclosure.

What is claimed is:

1. A converter, comprising:
a switching unit;
an energy storage unit storing energy from DC input power and then generating an output voltage, depending on a switching operation of the switching unit; and
a switching control unit turning on the switching unit when a voltage between one terminal and the other terminal of the switching unit reaches a lowest point of a resonance waveform,
wherein the switching control unit includes:
a voltage detection unit detecting the voltage between one terminal and the other terminal at the time of the resonance waveform;
a first signal output unit outputting a first signal when the voltage detected by the voltage detection unit reaches a change point of a slope corresponding to the lowest point of the resonance waveform; and
a switching driving unit turning on the switching unit in response to the first signal.

2. The converter according to claim 1, wherein a voltage level of the DC input power is more than 50% of a voltage level of the output voltage.

3. The converter according to claim 1, wherein the first signal output unit outputs the first signal when the slope of voltage detected by the voltage detection unit is changed from a negative direction to a positive direction.

4. The converter according to claim 1, wherein the first signal output unit includes a differentiator having one terminal connected to the voltage detection unit to detect information on the slope of voltage detected by the voltage detection unit.

5. The converter according to claim 4, wherein the first signal output unit outputs the first signal when a direction of current flowing in the differentiator is changed from a negative direction to a positive direction.

6. The converter according to claim 4, wherein the first signal output unit outputs the first signal together with detecting the change point of the slope, depending on an enable signal, and
the first signal output unit further includes:
a first comparator comparing a differential voltage corresponding to a current flowing in the differentiator with a first reference voltage and outputs a comparison signal depending on a comparison result; and
a signal output terminal outputting the first signal depending on the comparison signal.

7. The converter according to claim 6, wherein the first comparator includes an inversion input terminal and a non-inversion input terminal, and
the inversion input terminal is applied with the first reference voltage and the non-inversion input terminal is applied with the differential voltage.

8. The converter according to claim 6, wherein the first reference voltage is a voltage obtained by sampling and holding the differential voltage when no change in slope is present.

9. The converter according to claim 6, wherein the first signal output unit further includes:
a voltage holding unit connected to the other terminal of the differentiator and constantly holding the differential voltage when the enable signal is turned on and off; and
a voltage level reducing unit connected to the first comparator and lowering a voltage level of the first reference voltage.

10. The converter according to claim 6, wherein the first signal output unit further includes:
a delay unit which delays the time until the first signal is output after the enable signal is turned on.

11. The converter according to claim 4, wherein the first signal output unit further includes:
a clamping transistor between the voltage detection unit and one terminal of the differentiator.

12. The converter according to claim 11, wherein the first signal output unit further includes:
a clamping voltage comparison unit which outputs the first signal when a voltage clamped by the clamping transistor is equal to or less than a zero voltage.

13. The converter according to claim 1, further comprising:
a sensing resistor connected between the other terminal of the switching unit and a ground.

14. The converter according to claim 13, wherein the switching control unit further includes:
a second signal output unit outputting a second signal using a feedback voltage corresponding to the output voltage and a sensing voltage which is generated from the sensing resistor.

15. The converter according to claim 14, wherein the switching driving unit turns off the switching unit in response to the second signal.

16. The converter according to claim 14, wherein the switching driving unit includes:
a third signal output unit outputting a third signal depending on the first and second signals; and
a switching driving signal output unit outputting a switching driving signal depending on the third signal to turn on/off the switching unit.

17. The converter according to claim 14, wherein the second signal output unit includes:
a second comparator comparing the feedback voltage with a second reference voltage to output a comparison voltage depending on a comparison result; and
a third comparator comparing the sensing voltage with the comparison voltage to output the second signal depending on a comparison result.

18. The converter according to claim 17, wherein the second signal output unit further includes:
a comparison voltage dividing unit connected between an output terminal of the second comparator and an input terminal of the third comparator and dividing the comparison voltage output from the second comparator and outputting a divided voltage to the input terminal of the third comparator.

19. The converter according to claim 1, wherein the voltage detection unit is configured of a plurality of capacitors connected between one terminal of the switching unit and a ground.

20. The converter according to claim 17, wherein the second comparator includes an inversion input terminal and a non-inversion input terminal, and
the inversion input terminal is applied with the feedback voltage and the non-inversion input terminal is applied with the second reference voltage.

21. The converter according to claim 17, wherein the third comparator includes an inversion input terminal and a non-inversion input terminal, and
the inversion input terminal is applied with the comparison voltage and the non-inversion input terminal is applied with the sensing voltage.

22. The converter according to claim 1, wherein the switching unit is connected to a snubber capacitor in parallel.

23. A switching control circuit controlling a switching operation of a switching device which controls a generation of an output voltage from DC input power by an energy storage device and turning on the switching device when a voltage between one terminal and the other terminal of the switching device reaches a lowest point of a resonance waveform, the switching control circuit comprising:
a voltage detection unit detecting the voltage between one terminal and the other terminal at the time of the resonance waveform;
a first signal output unit outputting a first signal when the voltage detected by the voltage detection unit reaches a change point of a slope corresponding to the lowest point of the resonance waveform; and
a switching driving unit turning on the switching device in response to the first signal.

24. The switching control circuit according to claim 23, wherein a voltage level of the DC input power is more than 50% of a voltage level of the output voltage.

25. The switching control circuit according to claim 23, wherein the first signal output unit outputs the first signal when the slope of voltage detected by the voltage detection unit is changed from a negative direction to a positive direction.

26. The switching control circuit according to claim 23, wherein the first signal output unit includes a differentiator having one terminal connected to the voltage detection unit to detect information on the slope of the voltage detected by the voltage detection unit.

27. The switching control circuit according to claim 26, wherein the first signal output unit outputs the first signal when a direction of current flowing in the differentiator is changed from a negative direction to a positive direction.

28. The switching control circuit according to claim 26, wherein the first signal output unit outputs the first signal together with detecting the change point of the slope, depending on an enable signal, and
the first signal output unit further includes:
a first comparator comparing a differential voltage corresponding to a current flowing in the differentiator with a first reference voltage and outputs a comparison signal depending on a comparison result; and
a signal output terminal outputting the first signal depending on the comparison signal.

29. The switching control circuit according to claim 28, wherein the first comparator includes an inversion input terminal and a non-inversion input terminal, and
the inversion input terminal is applied with the first reference voltage and the non-inversion input terminal is applied with the differential voltage.

30. The switching control circuit according to claim 28, wherein the first reference voltage is a voltage obtained by sampling and holding the differential voltage when no change in slope is present.

31. The switching control circuit according to claim 28, wherein the first signal output unit further includes:
a voltage holding unit connected to the other terminal of the differentiator and constantly holding the differential voltage when the enable signal is turned on and off; and
a voltage level reducing unit connected to the first comparator and lowering a voltage level of the first reference voltage.

32. The switching control circuit according to claim 28, wherein the first signal output unit further includes:
a delay unit which delays the time until the first signal is output after the enable signal is turned on.

33. The switching control circuit according to claim 26, wherein the first signal output unit further includes:
a clamping transistor between the voltage detection unit and one terminal of the differentiator.

34. The switching control circuit according to claim 33, wherein the first signal output unit further includes:
a clamping voltage comparison unit which outputs the first signal when a voltage clamped by the clamping transistor is equal to or less than a zero voltage.

35. The switching control circuit according to claim 23, further includes:
a second signal output unit outputting a second signal using a feedback voltage corresponding to the output voltage and a sensing voltage which is generated from a sensing resistor,
wherein the sensing resistor is connected between the other terminal of a switching unit and a ground.

36. The switching control circuit according to claim 35, wherein the switching driving unit turns off the switching unit in response to the second signal.

37. The switching control circuit according to claim 35, wherein the switching driving unit includes:
a third signal output unit outputting a third signal depending on the first and second signals; and
a switching driving signal output unit outputting a switching driving signal depending on the third signal to turn on/off the switching unit.

38. The switching control circuit according to claim 35, wherein the second signal output unit includes:
a second comparator comparing the feedback voltage with a second reference voltage to output a comparison voltage depending on a comparison result; and
a third comparator comparing the sensing voltage with the comparison voltage to output the second signal depending on a comparison result.

39. The switching control circuit according to claim 38, wherein the second signal output unit further includes:
a comparison voltage dividing unit connected between an output terminal of the second comparator and an input terminal of the third comparator and dividing the comparison voltage output from the second comparator and outputting a divided voltage to the input terminal of the third comparator.

40. The switching control circuit according to claim 23, wherein the voltage detection unit is configured of a plurality of capacitors connected between one terminal of a switching unit and a ground.

41. The switching control circuit according to claim 38, wherein the second comparator includes an inversion input terminal and a non-inversion input terminal, and
the inversion input terminal is applied with the feedback voltage and the non-inversion input terminal is applied with the second reference voltage.

42. The switching control circuit according to claim 38, wherein the third comparator includes an inversion input terminal and a non-inversion input terminal, and
the inversion input terminal is applied with the comparison voltage and the non-inversion input terminal is applied with the sensing voltage.

43. The switching control circuit according to claim 23, wherein a switching unit is connected to a snubber capacitor in parallel.

44. A switching controlling method controlling a switching operation of a switching device controlling a generation of an output voltage from DC input power by an energy storage device and turning on the switching device when a voltage between one terminal and the other terminal of the switching device reaches a lowest point of a resonance waveform, the switching controlling method comprising:
detecting the voltage between one terminal and the other terminal at the time of the resonance waveform;
outputting a first signal when a detected voltage between one terminal and the other terminal reaches a change point of a slope corresponding to the lowest point of the resonance waveform; and
turning on the switching device in response to the first signal.

45. The switching controlling method according to claim 44, wherein in the outputting of the first signal, the first signal is output when the slope of the detected voltage between one terminal and the other terminal is changed from a negative direction to a positive direction.

46. The switching controlling method according to claim 44, further comprising:
detecting a feedback voltage corresponding to the output voltage;
detecting a sensing voltage;
outputting a second signal using a detected feedback voltage and a detected sensing voltage; and
turning off the switching device in response to the second signal,
wherein the sensing voltage is generated by a sensing resistor which is connected between the other terminal of the switching device and a ground.
